(19) United States
(12) Patent Application Publication
(10) Pub. No.: US 2002/0008144 A1
(43) Pub. Date: Jan. 24, 2002

(54) FOCUSED LIGHT SOURCE OF A SCANNER

(76) Inventor: PING-CHIH WANG, HSINCHU (TW)

Correspondence Address: WINSTON HSU, SF. 389, FU-HO ROAD, YUNGHO CITY, TAIPEI, TW

(21) Appl. No.: 09/404,316

(22) Filed: Sep. 24, 1999

(30) Foreign Application Priority Data
Aug. 27, 1999 (TW) 88214698

(51) Int. Cl. G06K 7/10

(52) U.S. Cl. 235/462.42

(57) ABSTRACT

The present invention provides a focused light source of a scanner, and the scanner comprises a housing and a scanning module installed in the housing for scanning a document. The light source is used for illuminating the document so that the scanning module can scan the document. The light source comprises a line-shaped light tube, a mask, and a focusing device. The mask has a line-shaped groove with a line-shaped opening and an arc-shaped cross section wherein the line-shaped light tube is fixed in the line-shaped groove in parallel and the inner surface of the line-shaped groove is reflective for reflecting the light emitted from the light tube toward the opening of the groove. The focusing device is installed at the opening of the groove for focusing onto the document the light emitted from the light tube and the light reflected from the inner surface of the groove.

### BACKGROUND OF THE INVENTION

1. Field of the Invention

The present invention relates to a light source, and more particularly, to a focused light source of a scanner.

2. Description of the Prior Art

A light source of a scanner is used to illuminate a document so that the scanner can scan the document. The light source must be sufficiently bright so that the sensor of the scanner can detect the light reflected from the document. When scanning, the document is scanned a line at a time. Hence, it is of no use to illuminate other areas of the document outside of the immediate scanning area. If the light can be focused onto this immediate scanning line area, the exposure time of the sensor can be shortened, thus the scanning speed of the scanner can be improved.

Please refer to FIG. 1 and FIG. 2. FIG. 1 is a schematic diagram of a light source 40 of a scanner according to the prior art. FIG. 2 is a schematic diagram of the light source 40 shown in FIG. 1 illuminating a document 22. The light source 40 of the scanner according to the prior art is a line-shaped light tube 42. When scanning a document 22 by using the light source 40, only a small portion of the light 44 emitted by the light tube 42 illuminates the scanning line area 24 on the document 22. Most of the light is lost. In other words, the light emitted by the light tube 42 is not effectively utilized.

Please refer to FIG. 3 and FIG. 4. FIG. 3 is a schematic diagram of an alternative light source 50 of a scanner according to the prior art. FIG. 4 is a schematic diagram of the light source 50 shown in FIG. 2 illuminating a document 22. The light source 50 comprises a light tube 42, and a reflecting surface 52 installed around the light tube 42. When scanning using the light source 50, part of the light 44 emitted by the light tube 42 will be reflected onto the document 22 via the reflection of the reflecting surface 52, but still a large portion of the light 44 is lost as it is not focused on the scanning line area 24. Hence, the light 44 emitted by the light tube 42 also is not effectively utilized.

### SUMMARY OF THE INVENTION

It is therefore a primary objective of the present invention to provide a light source of a scanner which can effectively utilize the emitted light to solve the above mentioned problem.

In a preferred embodiment, the present invention provides a light source of a scanner, the scanner comprising a housing and a scanning module installed in the housing for scanning a document, the light source being used to illuminate the document so that the scanning module can scan the document, the light source comprising:

a line-shaped light tube;

a mask having a line-shaped groove with a line-shaped opening and an arc-shaped cross section wherein the line-shaped light tube is fixed in the line-shaped groove in parallel and the inner surface of the line-shaped groove is reflective for reflecting the light emitted from the light tube toward the opening of the groove; and

a focusing device installed at the opening of the groove for focusing the light emitted from the light tube and the light reflected from the inner surface of the groove onto the document.

It is an advantage of the present invention that the light source of the present invention can effectively utilize the light emitted by the light tube, reduce the exposure time of the sensor and thus increase the scanning speed of the scanner.

This and other objectives of the present invention will no doubt become obvious to those of ordinary skill in the art after having read the following detailed description of the preferred embodiment which is illustrated in the various figures and drawings.

### BRIEF DESCRIPTION OF THE DRAWINGS

FIG. 1 is a schematic diagram of a light source of a scanner according to the prior art.

FIG. 2 is a schematic diagram of the light source shown in FIG. 1 illuminating a document.

FIG. 3 is a schematic diagram of an alternative light source of a scanner according to the prior art.

FIG. 4 is a schematic diagram of the light source shown in FIG. 2 illuminating a document.

FIG. 5 is a schematic diagram of a scanner utilizing a light source of the present invention.

FIG. 6 is a schematic diagram of a light source according to the present invention.

FIG. 7 is an exploded view of the light source shown in FIG. 6.

FIG. 8 is a schematic diagram of the light source shown in FIG. 6 illuminating a document.

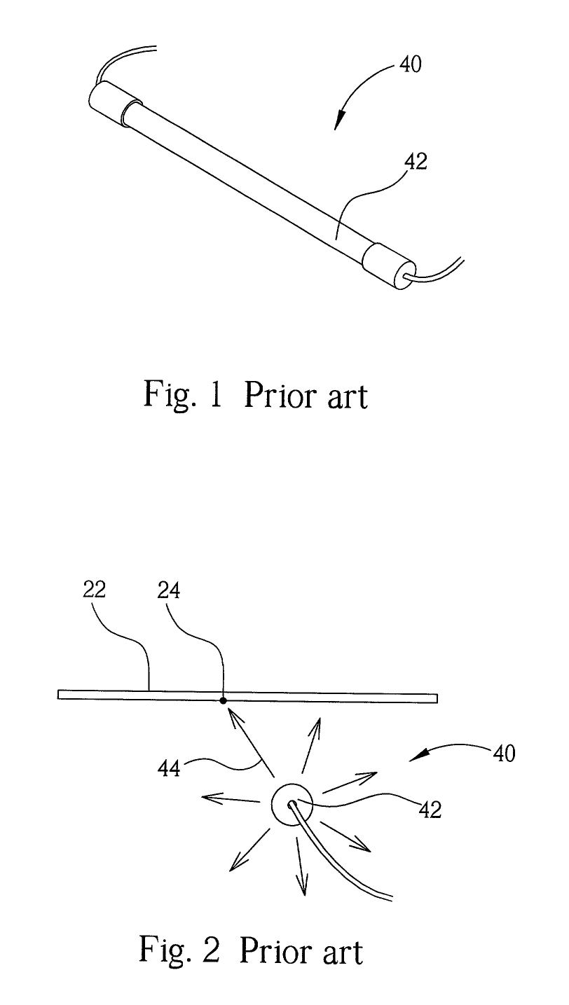

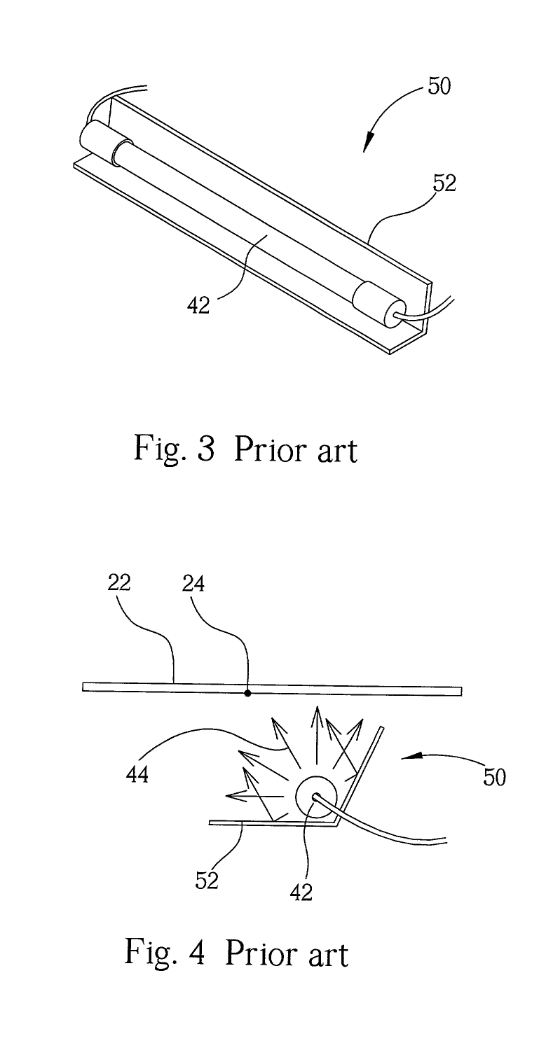

### DETAILED DESCRIPTION OF THE PREFERRED EMBODIMENT

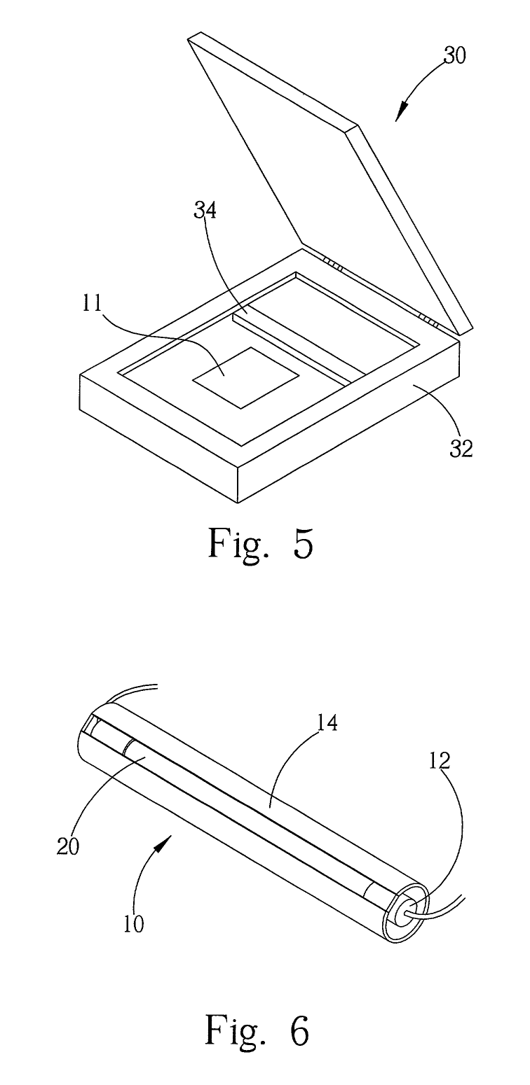

Please refer to FIG. 5 and FIG. 6. FIG. 5 is a schematic diagram of a scanner 30 utilizing a light source 10 of the present invention as part of a scanning module 34. FIG. 6 is a schematic diagram of a light source 10 according to the present invention. The present invention provides a light source 10 of a scanner 30, and the scanner 30 comprises a housing 32 and a scanning module 34 installed in the housing 32 for scanning a document 11. The scanning module 34 can be moved forward and backward inside the housing 32 of the scanner 30 and the light source 10 is a fixed component of the scanning module 34 for illuminating the document 11 so as to enable the scanning module 34 to scan the document 11. The scanning module 34 comprises a CCD (charge-coupled device) (not shown) or a CIS (contact image sensor) (not shown) for detecting the light transmitted from the document 11.

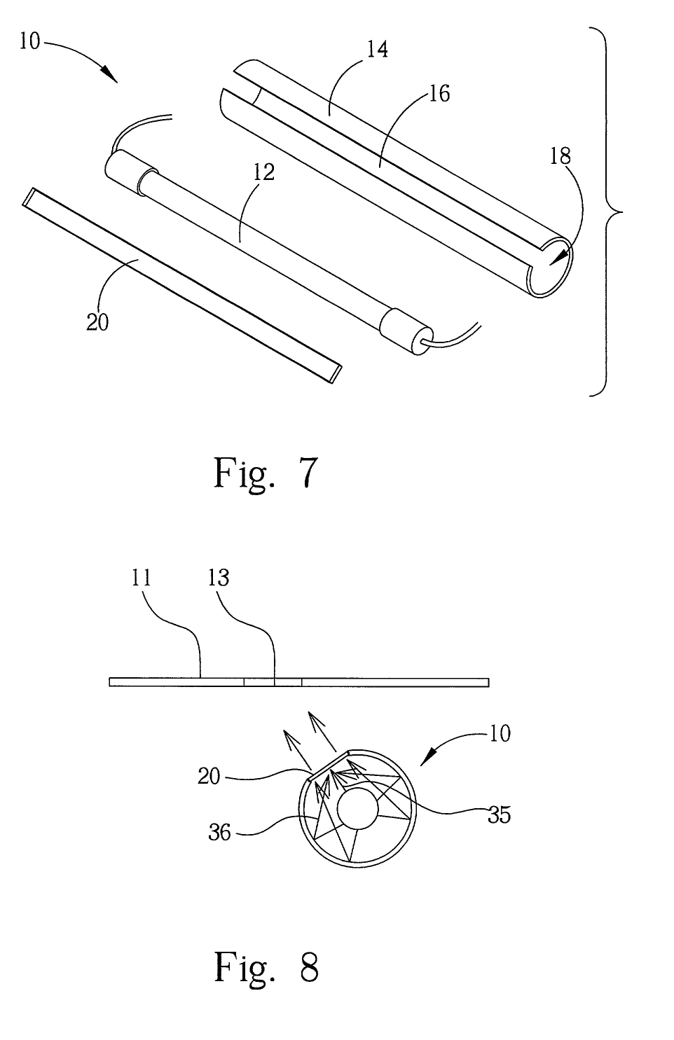

Please refer to FIG. 7 and FIG. 8. FIG. 7 is an exploded view of the light source 10 shown in FIG. 6. FIG. 8 is a schematic diagram of the light source 10 shown in FIG. 6 illuminating a document 11. The light source 10 comprises a line-shaped light tube 12, a mask 14, and a focusing lens 20. The line-shaped light tube 12 can be a typical cathode-ray tube or a light emitting diode. The mask 14 is made of aluminum alloy, or can be made of some alternative alloy, plastic or reflective plastic film. The mask 14 has a line-shaped groove 18 with a line-shaped opening 16 and an arc-shaped cross section. The line-shaped light tube 12 is fixed in the line-shaped groove 18 in parallel and the inner surface of the line-shaped groove 18 is reflective so that light emitted from the light tube 12 will be reflected towards the opening 16 of the groove 18. The focusing lens 20 is installed at the opening 16 of the groove 18 for focusing onto the document 11 the light 35 emitted from the light tube 12 and the light 36 reflected from the inner surface of the groove 18. The focusing lens 20 can also be a focusing film like BEF (brightness enhancement film) of the 3M company.

When scanning module 34 is scanning, most of the light emitted by the line-shaped light tube 12 of the light source 10 will be reflected by the inner surface of the line-shaped groove 18 of the mask 14 and then pass through the focusing lens 20 at the line-shaped opening 16. Then, the light 35, 36 transmitted from the light tube 12 and the inner surface of the line-shaped groove 18 is focused onto a line-shaped scanning area 13 on the document 11. Consequently, the light source 10 of the present invention can effectively utilize the light emit ted by the light tube 12 to enhance the luminosity needed when scanning. This enhanced luminosity shortens the exposure time of the sensor and enhances the scanning speed and scanning quality.

Compared to the light sources 40, 50 according to the prior art, the light source 10 of the present invention has a mask 14 wherein the inner surface of the groove 18 can gather the light emitted by the light tube 12 and the focusing lens 20 can focus onto the document 11 the light transmitted from the light tube 12 and the inner surface of the groove 18. Hence, the light source 10 of the present invention effectively utilizes the light emitted by the light tube 12, and focuses the light so as to enhance the luminosity needed while scanning. With a greater luminosity at the scanning area, the exposure time of the sensors is shortened and the scanning speed and quality of the scanner is enhanced.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A light source of a scanner, the scanner comprising a housing and a scanning module installed in the housing for scanning a document, the light source being used for illuminating the document so that the scanning module can scan the document, the light source comprising:
a line-shaped light tube;
a mask having a line-shaped groove with a line-shaped opening and an arc-shaped cross section wherein the line-shaped light tube is fixed in the line-shaped groove in parallel and the inner surface of the line-shaped groove is reflective for reflecting the light emitted from the light tube toward the opening of the groove; and
a focusing device installed at the opening of the groove for focusing the light emitted from the light tube and the light reflected from the inner surface of the groove onto the document.

2. The light source of claim 1 wherein the mask is made of aluminum alloy.

3. The light source of claim 1 wherein the focusing device is a focusing lens.

4. The light source of claim 1 wherein the scanning module can be moved forward and backward inside the housing of the scanner and the light source is fixed in the scanning module for illuminating the document so as to enable the scanning module to scan the document.

5. The light source of claim 4 wherein the scanning module comprises a CCD (charge-coupled device) for sensing the light transmitted from the document.

6. The light source of claim 4 wherein the scanning module is a CIS (contact image sensor) for sensing the light transmitted from the document.
